(19) United States
(12) Patent Application Publication
(10) Pub. No.: US 2018/0196191 A1
(43) Pub. Date: Jul. 12, 2018

(54) OPTICAL FIBER WITH BRAGG GRATING AND THIN FILM COATING AND CONNECTOR

(71) Applicant: 3M INNOVATIVE PROPERTIES COMPANY, St. Paul, MN (US)

(72) Inventors: Ding Wang, Austin, TX (US); Raman K. Selli, Austin, TX (US)

(21) Appl. No.: 15/736,106

(22) PCT Filed: Jul. 7, 2016
(86) PCT No.: PCT/US2016/041272

§ 371 Date: Dec. 13, 2017

Related U.S. Application Data
(60) Provisional application No. 62/191,062, filed on Jul. 10, 2015.

(51) Int. Cl. G02B 6/02; G02B 6/38

(52) U.S. Cl. CPC G02B 6/02076; G02B 6/3846; G02B 6/3845

(57) ABSTRACT

An article comprises an optical fiber having a first end with a first end surface having a multilayer thin film filter coating deposited thereon, a second end with a second end surface, and a fiber Bragg grating formed within the optical fiber between the first and second ends.

### BACKGROUND

### Field of the Invention

The present invention is directed to an article that includes an optical fiber, in particular, an optical fiber having a Bragg grating and a thin film filter coating.

### Related Art

Many of today's copper access networks are being replaced by fiber networks in order to meet the ever increasing demand of bandwidth. Monitoring of these fiber networks is essential in order to assure quality of service and allow common use of one network by different service providers. Today's Passive Optical Networks (PONs) deliver higher bandwidth solutions to both residential and business customers. PONs can include point to point and point to multi-point passive optical networks. Access network construction and customer churn place considerable stress on network operators.

The expansion of PONs, where the signal on a single optical fiber is split into separate fibers to run to each subscriber, has triggered the need for cost-effective testing. One technique for testing fiber optic links from a remote location is to send a signal down the fiber and observe the reflective events. For example, an established method for this task is the so-called OTDR technology which uses a test head in the central office and test reflectors at each customer premise. To prevent the interruption of service, light whose wavelength is different from that of the communication light is used for testing. In a single fiber, the time of flight and reflected power provides information about the quality of the fiber path. In a PON system the light is split and travels independently down each branch. The resulting back-reflected light is a conglomeration of all the legs and analyzing the quality of the individual transmission lines is difficult.

There are conventional reflector solutions that can either be implemented inside an optical connector or used as a stand-alone component. One type uses fiber Bragg gratings. Alternatively, thin film filter solutions are described in which discrete filter elements are inserted in the optical path. For example, see U.S. Pat. No. 5,037,180; JP 11231139; and EP 2264420.

### SUMMARY

According to a first aspect of the present invention, an article comprises an optical fiber having a first end with a first end surface having a multilayer thin film filter coating deposited thereon, a second end with a second end surface, and a fiber Bragg grating formed within the optical fiber between the first and second ends.

In another aspect, the first end surface has an angle from about 1 degree to about 10 degrees with respect to a plane that is perpendicular to an optical axis of the fiber. In another aspect, the second end surface has a multilayer thin film filter coating deposited thereon. In another aspect, the fiber has a length of from about 5 mm to about 50 mm. In another aspect, the thin film filter coating transmits light having a wavelength of about 1260 nm to about 1600 nm and reflects light having a wavelength of about 1620 nm to about 1690 nm. In another aspect, the fiber Bragg grating has a transmission of <25% and a reflectivity of >75% at 1650 nm (+/−10 nm).

According to another aspect of the invention, an article comprises a first optical fiber having a first end with a first end surface having a multilayer thin film filter coating deposited thereon, a second end with a second end surface, and a first fiber Bragg grating formed within the first optical fiber between the first and second ends. The article further comprises a second optical fiber having a second fiber Bragg grating formed therein, wherein an end surface of the second optical fiber is attached to the first optical fiber at the first end surface.

According to another aspect of the invention, an article comprises a ferrule and an optical fiber having a first end with a first end surface having a multilayer thin film filter coating deposited thereon, a second end with a second end surface, and a fiber Bragg grating formed within the optical fiber between the first and second ends, wherein at least the portion of the optical fiber having the fiber Bragg grating formed therein is disposed within the ferrule. In another aspect, an entire length of the optical fiber is disposed within the ferrule.

According to another aspect of the invention, an optical device comprises any of the aforementioned articles. In another aspect, the optical device comprises an optical fiber connector. In another aspect, the optical device comprises an optical fiber receptacle. In another aspect, the optical device comprises an optical jumper. In another aspect, the optical device comprises an optical adapter. In another aspect, the optical device further comprises a mechanical splice device, wherein the second end of the optical fiber mates with a field fiber in a splice element of the mechanical splice device. In another aspect, the optical fiber comprises a stub fiber. In another aspect, an isolation of a data band signal from a monitoring band is at least 50 dB.

According to another aspect of the invention, a passive optical network (PON) comprises any of the aforementioned optical devices.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1 is a schematic view of an article according to a first aspect of the invention.

FIG. 2 is a schematic view of an article according to another aspect of the invention.

FIG. 3 is a schematic view of an article according to another aspect of the invention.

FIG. 4 is a schematic view of an article according to another aspect of the invention.

FIG. 5 is a schematic view of an optical connector according to another aspect of the invention.

FIG. 6 is an exploded view of an optical connector according to another aspect of the invention.

FIGS. 7A and 7B are views of optical devices according to other aspects of the invention.

FIG. 8 is a plot showing a transmission spectrum for a sample article according to an aspect of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention.

The present invention is directed to an article comprising an optical fiber having a multilayer thin film filter coating disposed on at least one end thereof and a Bragg grating formed therein. The optical fiber can be integrated into an optical fiber connector. For example, the optical fiber having a thin film filter and fiber Bragg grating can be integrated into an optical connector, receptacle, or coupler disposed at a subscriber/customer location. In particular, the articles and devices of the exemplary embodiments can be of compact length and, in some cases, can be capable of straightforward termination. The exemplary connector(s) described herein can be readily installed and utilized for Fiber To The Home (FTTH) and/or Fiber To The X (FTTX) network installations. In particular, such a connector can be used as a component in point to point monitoring.

Testing a transmission line using a reflective filter located at the end of the communications line can be done from a remote maintenance center. This type of monitoring enables the isolation of fiber faults, reducing maintenance costs and improving service reliability. As mentioned previously, there are two kinds of conventional technologies that have been separately used for monitoring filter in FTTX and other point to point connections based on OTDR equipment—fiber Bragg grating (FBG) technology and multilayer thin film (TF) filter technology. Both technologies can enable selective high reflection of the monitoring wavelength only and high transmission of the data band. However, each technology by itself has its strengths and shortcomings.

For example, FBG has good back reflection performance in the data band and the monitoring band, but it has large transmission loss in the data band and temperature sensitivity if there is no temperature control. In addition, a fiber with multiple FBGs has a large footprint (with each FBG usually longer than 10 mm in order to provide +/−10 nm reflection bandwidth). Moreover, each FBG is fabricated on a one-by-one basis. In contrast, TF filter coatings (or TF filters) have very low transmission loss in data band and an extremely small thickness (e.g., <50 μm). In addition, TF filters and can be deposited onto a large number of fibers in parallel. TF filters are not temperature sensitive, but TF filters can have less than optimal back reflection performance at the data band (as compared to an FBG). Also, there can be a limit on the maximum thickness of a TF filter coating that can be deposited on optical fiber end surface.

For some applications in optical monitoring, it is beneficial to have: (a) high back reflection loss in the data band within the reflection spectrum; (b) high isolation between the data band and the monitoring wavelength within the transmission spectrum; and (c) low transmission loss in the data band within the transmission spectrum. According to an aspect of the invention, an optical fiber having a TF filter deposited on at least one end and a FBG fabricated therein can achieve this performance criteria. In addition, for a FBG that is formed near a coated end surface of the fiber, that fiber end surface can be angle cleaved.

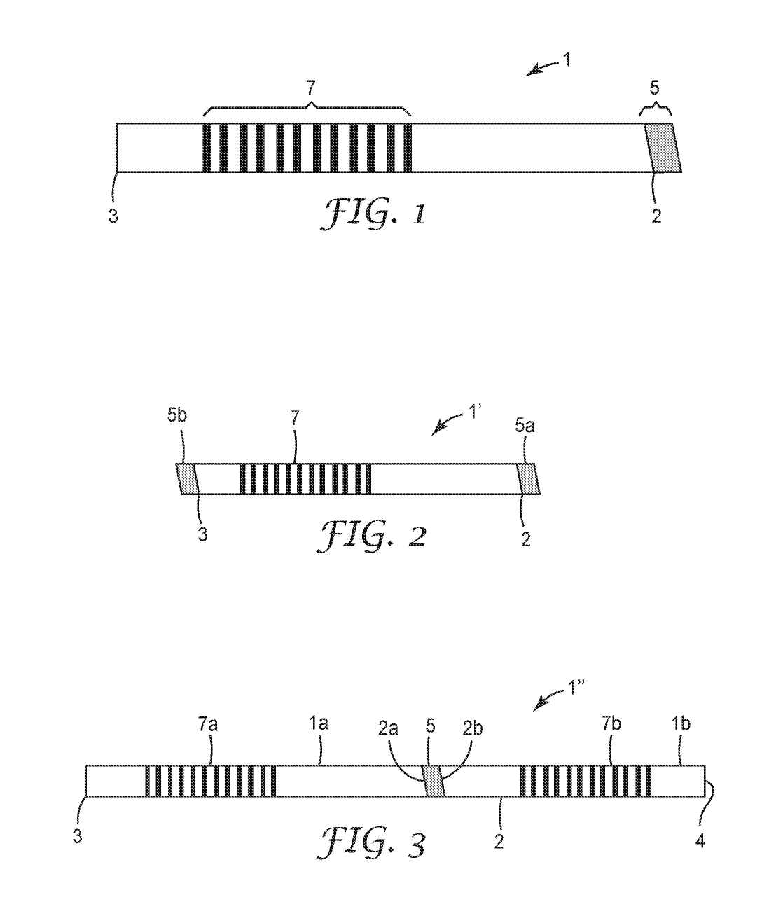

FIG. 1 shows a first aspect of the present invention, an article comprising an optical fiber 1 having a first end 2 and a second end 3. The optical fiber 1 can comprise a conventional optical fiber, such as a standard single mode or multimode optical fiber, such as SMF 28 (available from Corning Inc.), having a glass core and cladding. The outer diameter can be a standard size, such as 125 μm. In many applications as described herein, optical fiber 1 is typically secured in a ferrule.

FBG 7 is written inside optical fiber 1. The FBG 7 can be formed using a conventional FBG writing technique known in the art. The FBG can have the following optical characteristics—certain wavelengths of incoming light will be reflected at a certain reflection value, for example >90% of the incoming light at 1650 nm (+/−10 nm). The physical length of the grating area can be as short as 5 mm, but can be increased in length based on desired reflection performance and bandwidth. In one aspect, FBG 7 can be 9 mm or shorter.

As shown in FIG. 1, at least one end of the optical fiber 1 (such as first end 2) is coated with multi-layer TF filter coating 5. In addition, in some aspects, fiber end surface 2 can be angle cleaved, such that end surface 2 has an angle of from about 2 degrees to about 20 degrees with respect to a plane perpendicular to the optical axis of the fiber, then coated with multilayer TF filter coating 5. In other aspects, fiber end surface 2 can have a standard cleave angle, such as 8 degree. By configuring the fiber end surface in this manner, the back reflection performance of the FBG at both the data band and the monitoring band in the reflection spectrum (low for data band, high for monitoring band) is maintained, the isolation of the transmission spectrum is improved, and the transmission loss of the data band of the transmission spectrum is kept low.

Alternatively, the first end surface 2 can be polished flat (i.e., being substantially parallel to the plane perpendicular to the optical axis), then coated with multilayer TF filter coating 5. Also, fiber end surface 3 can also be either flat polished or angle polished.

In an aspect of the invention, fiber 1 can have a length of from about 5 mm to about 200 mm, from about 5 mm to about 50 mm, or from about 5 mm to about 20 mm.

In an aspect of the invention, coating 5 comprises a thin film filter coating that can be designed to pass certain wavelengths of light (e.g., light having a wavelength of between 1260 nm to about 1600 nm) and reflect another wavelength of light (e.g., light having a wavelength of about 1620 nm to about 1690 nm). The transmission and reflection characteristics of the in-band and out-of-band regions are preferably specified and controlled for proper system performance. For example, the IEC 61753-041-2 and 61753-042-2 standards describe optical characteristics of filters used in a PON monitoring system. In the reflection requirements for the 041-2 standard, there are two grades—S (return loss better than 26 dB) and T (return loss better than 35 dB).

The TF filter coating can comprise a multilayer optical coating that can be deposited onto end surface 2 or end surface 3. In one aspect, the deposited coating is substantially uniform on the end surface. In some aspects, optical fiber 1 can be utilized as a stub fiber in an optical fiber connector, in particular, a fiber stub protruding from a ferrule portion of the optical fiber connector towards an interior region of the connector. This configuration combines connectivity and a test reflector in a single low cost device without having to significantly modify the design of an existing connector.

Coating 5 can be deposited using a thin film vapor deposition or plasma coating process. In one aspect, the process can include coating multiple optical fiber end surfaces at the same time. Areas where the coating is undesirable can be shielded or masked to prevent the coating from attaching to the object (fiber).

The multilayer wavelength selective coating 5 can comprise a low pass thin-film interference filter capable of meeting an out-of-band reflection specification of 35 dB, and includes a plurality of layers, with precise thickness control of each layer. When implemented in a communications network, such as a PON, adding a filter in front of the subscriber's home that reflects only the test light provides an event that is easily distinguished after the splitter. Such a filter can be integrated into a field installed connector which can be introduced into the PON during the installation process providing a well-defined event for the link analysis. Testing a transmission line using a reflective filter deposited on the end can be performed from a remote maintenance center. This configuration enables the isolation of fiber faults, reducing maintenance costs and improving service reliability.

For example, in one approach, a network signal (having a data band and a monitoring band) can enter fiber 1 from the FBG side first. When end surface 2, having the TF filter coating 5 deposited thereon, has a cleave angle >1 degree, this configuration will ensure that the monitoring band signal can be highly reflected back by the FBG to the optical line terminal (OLT) control center, and the back reflection at data band from TF filter coating will be reflected into the fiber cladding.

Further, as shown in more detail with respect to FIG. 2, both ends of an optical fiber 1′ can coated with a TF filter coating. In this example, fiber 1′ has a first end 2 and a second end 3. The optical fiber 1′ can comprise a conventional optical fiber, such as described above. A FBG 7 is written inside optical fiber 1′ and can be formed as described above. Both ends of the optical fiber 1′ are coated with a multi-layer TF filter coating, as first end 2 is coated with TF filter coating 5a and second fiber end 3 is coated with TF filter coating 5b. In addition, in some aspects, fiber end surfaces 2 and 3 can be angle cleaved or flat.

In another aspect of the invention, an optical fiber can include multiple FBGs. For example, as shown in FIG. 3, fiber 1″ has a first end 3 and a second end 4. The optical fiber 1″ can comprise 2 conventional optical fibers, such as described above, that are joined together. First optical fiber 1a can include a first FBG 7a written in optical fiber 1a in a manner as described above. Second optical fiber 1b can include a second FBG 7b written in optical fiber 1b in a manner as described above. First fiber 1a has a second end 2a and second fiber 1b has a second end 2b. A multi-layer TF filter coating 5, such as those described above, can be coated onto either end 2a or 2b, with the ends coupled together to form fiber 1″. In addition, in some aspects, fiber end surfaces 2a and 2b can be angle cleaved or flat.

In other aspects of the invention, optical fiber 1 (and/or fibers 1′ and 1″) can be incorporated in an optical device such as an optical connector, an optical receptacle, an optical plug, or an optical coupler. In one aspect, referring to optical fiber 1, the optical fiber is oriented in the optical device such that incoming light (system signal) from a central office or network enters end surface 3 first, thus being incident on the FBG first in order to maintain good back reflection performance (low for data band, high for monitoring band), as well as excellent isolation.

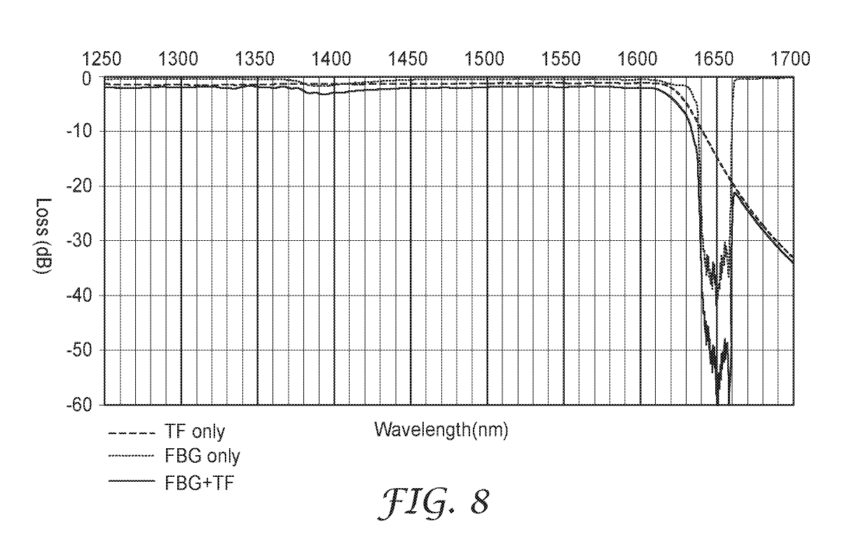

An example of the improved isolation provided by an optical fiber that is constructed in a manner similar to optical fiber 1 is described below with respect to FIG. 8. In that experiment, the isolation of the data band signal from the monitoring band is increased from 35 dB to over 50 dB. Further description of FIG. 8 is provided below.

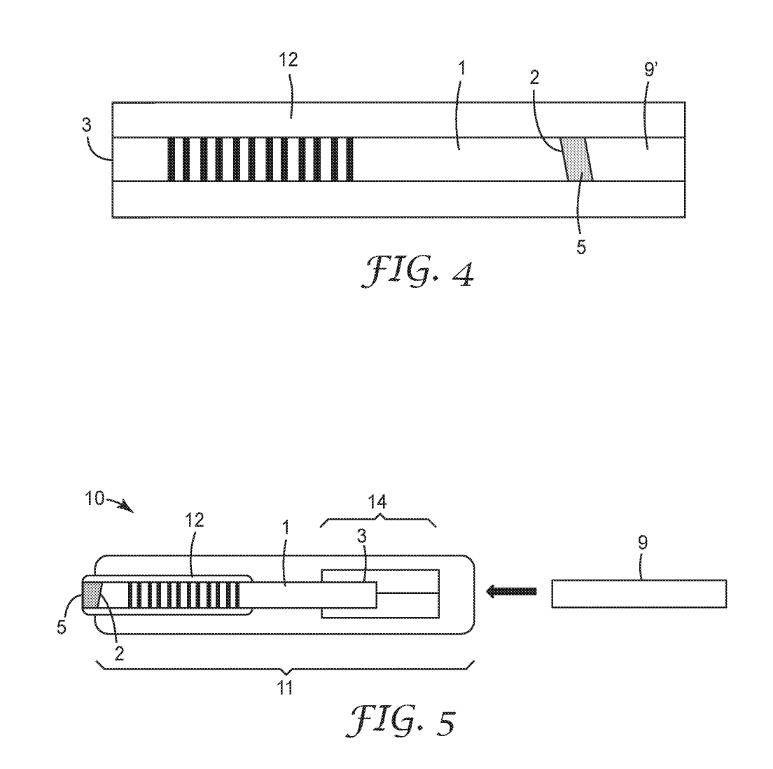

As mentioned, in another aspect of the invention, optical fiber 1 can be incorporated into an optical device. For example, FIG. 4 shows an article that includes an optical fiber 1 secured in a ferrule 12. In this example, fiber 1 has a first end 2 and a second end 3. The optical fiber 1 can comprise a conventional optical fiber, such as described above. A FBG 7 is written inside optical fiber 1 and can be formed as described above. First end 2 of the optical fiber 1 is coated with a multi-layer TF filter coating 5, such as described above. In addition, in some aspects, one or both of fiber end surfaces 2 and 3 can be angle cleaved or flat. In this configuration, optical fiber 1 is housed in a ferrule. In one aspect, ferrule 12 comprises a ceramic ferrule, where the ceramic material has a limited thermal expansion, so any induced wavelength drift can be minimized due to the confinement of the FBG 7 within the ceramic ferrule 12. In addition, a short fiber piece 9′ can be bonded or otherwise attached to the end surface 2 of optical fiber 1. In this manner, the TF coating 5 can be protected from damage during coupling operations.

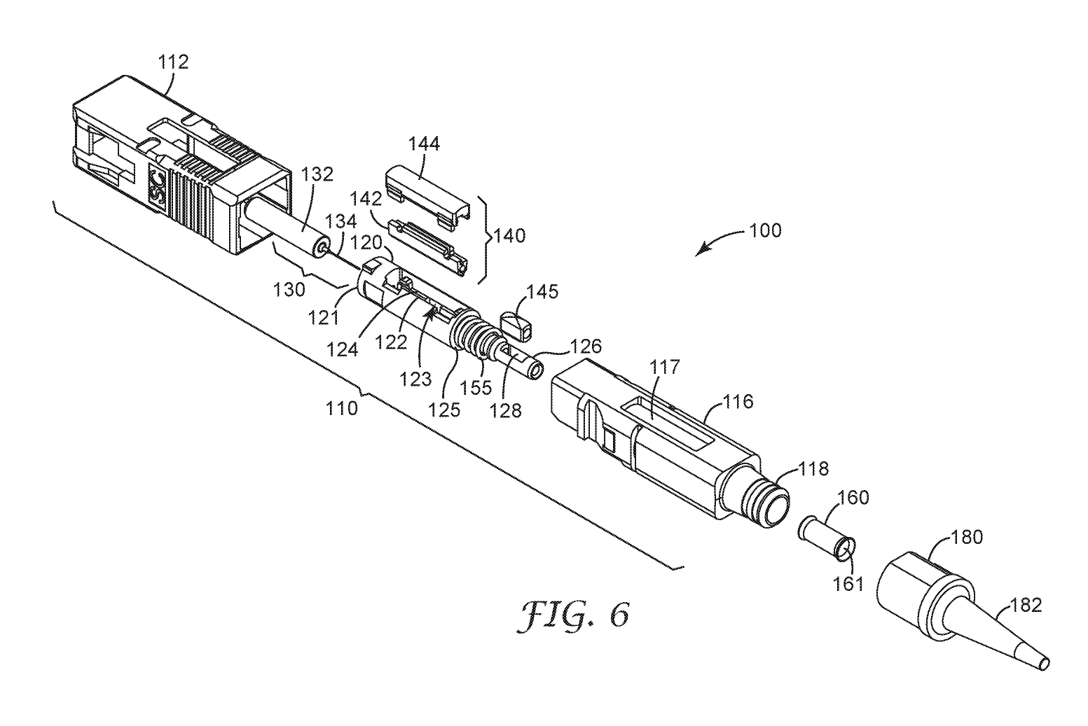

In another aspect, optical fiber 1 can be utilized as a fiber stub in an optical connector, such as, for example, a field terminable optical fiber connector. FIG. 5 shows a schematic diagram of an optical fiber connector 10 (a more detailed view of an exemplary optical fiber connector 100 is shown in FIG. 6). Optical connector 10 has a connector body 11 that includes a ferrule 12 that houses a portion of optical fiber 1. In addition, optical connector 10 also includes a splice device 14, such as a mechanical splice device. In this example, optical fiber 1 is to be spliced with a field fiber 9 in the splice device 14. The field fiber 9 can be, for example, a drop fiber from a communications line. In some aspects, an index matching gel can be provided in the mechanical splice device 14 at the mating end faces to eliminate any air gap between end surface 3 and the mating end of field optical fiber 9. In this aspect, the FBG 7 is housed inside the ferrule, while the coated end 2, having a TF filter coating 5, is disposed at the ferrule end face.

In more detail, FIG. 6 shows such an exemplary optical connector 100. Please note that as shown in FIG. 6, exemplary optical connector 100 is configured as having an SC format. However, as would be apparent to one of ordinary skill in the art given the present description, optical connectors having other standard formats, such as ST, FC, and LC connector formats can also be provided.

SC-type optical fiber connector 100 can include a connector body having a housing 110 and a fiber boot 180. In this exemplary embodiment, housing 110 includes an outer shell 112, configured to be received in an SC receptacle (e.g., an SC coupling, an SC adapter, or an SC socket), and a backbone 116 that is housed inside the shell 112 and that provides structural support for the connector 100. In addition, backbone 116 further includes at least one access opening 117, which can provide access to actuate a mechanical splice disposed within the connector. Backbone 116 can further include a mounting structure 118 that provides for coupling to the fiber boot 180, which can be utilized to protect the optical fiber from bend related stress losses. According to an exemplary embodiment of the present invention, shell 112 and backbone 116 are formed or molded from a polymer material, although metal and other suitably rigid materials can also be utilized. Shell 112 is preferably secured to an outer surface of backbone 116 via snap fit.

Connector 100 further includes a collar body 120 that is disposed within the connector housing and retained therein. The collar body 120 is a multi-purpose element that can house a fiber stub assembly 130, a mechanical splice 140, and a fiber buffer clamp, such as buffer clamp element 145. The collar body is configured to have some limited axial movement within backbone 116. For example, the collar body 120 can include a collar or shoulder 125 that can be used as a flange to provide resistance against spring 155, interposed between the collar body and the backbone, when the fiber stub assembly 130 is inserted in a receptacle. Collar body 120 can be formed or molded from a polymer material, although metal and other suitable materials can also be utilized. For example, collar body 120 can comprise an injection-molded, integral material.

In particular, collar body 120 includes a first end portion 121 having an opening to receive and house a fiber stub assembly 130, which includes a ferrule 132 having an optical fiber 134 secured therein. Optical fiber 134 can be constructed in the same manner as optical fiber 1 described above. Ferrule 132 can be formed from a ceramic, glass, plastic, or metal material to support the optical fiber 134 inserted and secured therein.

Optical fiber 134 is inserted through the ferrule 132, such that a first fiber stub end slightly protrudes from or is coincident or coplanar with the end face of ferrule 132. As shown in FIG. 5, this first fiber stub end can correspond to fiber end surface 2, which is coated with a TF filter coating 5. The FBG (such as FBG 7 from FIG. 5) can be disposed within the interior of the ferrule 132. A second end of the fiber 134 extends part-way into the interior of the connector 100 and can be flat or angle cleaved. This second end of fiber 134, which can correspond to fiber end surface 3 of fiber 1 (as shown in FIG. 5) can be utilized to splice a second optical fiber (such as a field fiber) during field termination.

In an alternative aspect, the orientation of the stub fiber can be reversed, such that the TF filter coated first end of the fiber 134 can extend part-way into the interior of the connector 100, and the second end face can be located at the ferrule end face.

In an exemplary aspect, fiber 134 is pre-installed and secured (e.g., by epoxy or other adhesive) in the ferrule 132, which is disposed in the first end portion 121 of collar body 120. Ferrule 132 is preferably secured within collar body via an epoxy or other suitable adhesive. Preferably, pre-installation of the fiber stub can be performed in the factory.

Collar body 120 further includes a splice element housing portion 123, which can have an opening 122 in which a mechanical splice 140 can be inserted and secured in the central cavity of collar body 120. In an exemplary embodiment, mechanical splice 140 comprises a mechanical splice device (also referred to herein as a splice device or splice), such as a 3M™ FIBRLOK™ mechanical fiber optic splice device, available from 3M Company, of Saint Paul, Minn.

For example, commonly owned U.S. Pat. No. 5,159,653, incorporated herein by reference in its entirety, describes an optical fiber splice device (similar to a 3M™ FIBRLOK™ II mechanical fiber optic splice device) that includes a splice element that comprises a sheet of ductile material having a focus hinge that couples two legs, where each of the legs includes a fiber gripping channel (e.g., a V-type (or similar) groove) to optimize clamping forces for conventional glass optical fibers received therein. The ductile material, for example, can be aluminum or anodized aluminum. In addition, a conventional index matching fluid can be preloaded into the V-groove region of the splice element for improved optical connectivity within the splice element. Other conventional mechanical splice devices can also be utilized in accordance with alternative aspects of the present invention and are described in U.S. Pat. Nos. 4,824,197; 5,102,212; 5,138,681; and 5,155,787, each of which is incorporated by reference herein, in their entirety.

Mechanical splice 140 allows a field technician to splice the second end of fiber stub 134 to a second optical fiber at a field installation location. The term “splice,” as utilized herein, should not be construed in a limiting sense since splice 140 can allow removal of a fiber.

In an exemplary embodiment, utilizing a 3M™ FIBRLOK™ II mechanical fiber optic splice device, splice device 140 can include a splice element 142 and an actuating cap 144. In operation, as the cap 144 is moved from an open position to a closed position (e.g. downward in the embodiment depicted in FIG. 6), one or more cam bars located on an interior portion of the cap 144 can slide over splice element legs, urging them toward one another. Preferably, cap 144 can include a cam having a length of about 0.200″. Two fiber ends, (e.g., one end of fiber 134 and one end of the field fiber) are held in place in grooves formed in the splice element and butted against each other and are spliced together in a channel, such as a V-groove channel to provide sufficient optical connection, as the element legs are moved toward one another.

Splice element 142 is mountable in a mounting device or cradle 124 (partially shown) located in portion 123 of collar body 120. In an exemplary embodiment, cradle 124 is integrally formed in collar body 120, e.g., by molding. Cradle 124 can secure (through e.g., snug or snap-fit) the axial and lateral position of the splice device 140. The mounting device 124 can be configured to hold the splice device 140 such that the splice device 140 cannot be rotated, or easily moved forward or backward once installed. The splice element 142 can be retained by clearance fit below one or more overhanging tabs provided in portion 123. The element receiving cradle 124 is configured to allow the splice element 142 to be inserted when tilted away from the retaining tabs. Once the splice element 142 is fully seated, it is then tilted toward the tabs which brings a portion of the element 142 under the tabs to retain it in a vertical direction. The cap 144 can then be placed over the element 142, as the legs of the cap 144 can extend along the sides of the element 142 and prevent the element from tilting away from the retaining tabs.

Further, collar body 120 includes a buffer clamping portion 126 that can be configured, e.g., by having at least one slot or opening 128, to receive a buffer clamping mechanism, such as a buffer clamp element 145. In an exemplary aspect, the buffer clamping portion 126 is disposed within the interior of the backbone 116 in the fully assembled connector.

According to an exemplary aspect, buffer clamping portion 126 can receive a buffer clamping element 145 that is configured to clamp a standard optical fiber buffer cladding, such as a 900 μm outer diameter buffer cladding, a 250 μm buffer cladding, or a fiber buffer cladding having an outer diameter being larger or smaller.

To activate the particular buffer clamping element 145, connector 100 further includes an actuation sleeve 160 having an opening 161 extending therethrough that is axially slidably received by the outer surface of buffer clamping portion 126. Sleeve 160 can be formed from a polymer or metal material. Preferably, the hardness of the sleeve 160 is greater than the hardness of the material forming the buffer clamping portion 126.

To prevent sharp fiber bends at the connector/fiber interface, a boot 180 can be utilized. In an exemplary aspect, boot 180 includes a conventional tapered tail 182. In an alternative aspect, boot 180 can include a funnel-shaped tail section, which provides a fiber guide to the field technician terminating the fiber and to also provide control of the minimum bend radius to prevent possible signal losses when the fiber is side-loaded. In addition, the boot can be coupled to a back surface of backbone via a rotatable mount. In a further alternative aspect (not shown), the boot can be formed from more than one material to provide a desired bend radius.

The exemplary connector 100 shown in FIG. 6 can provide for straightforward field fiber termination for 250 μm, 900 μm, or non-standard buffer coated optical fiber, without the need for a power source, adhesive, costly installation tools, or field polishing. The exemplary connector can have an overall length of less than two inches. In addition, the connector includes both an integral splice and a buffer clamp internal to the connector backbone.

Alternatively, the optical fibers described herein can be utilized in a different field terminable optical connector. One such alternative field terminable connector is described in U.S. Pat. No. 8,573,859, incorporated by reference herein in its entirety.

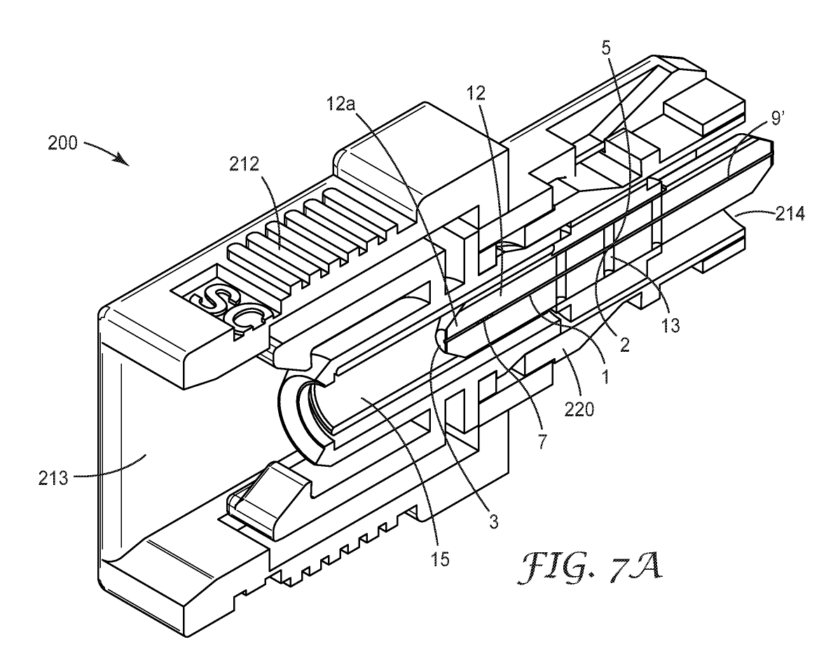

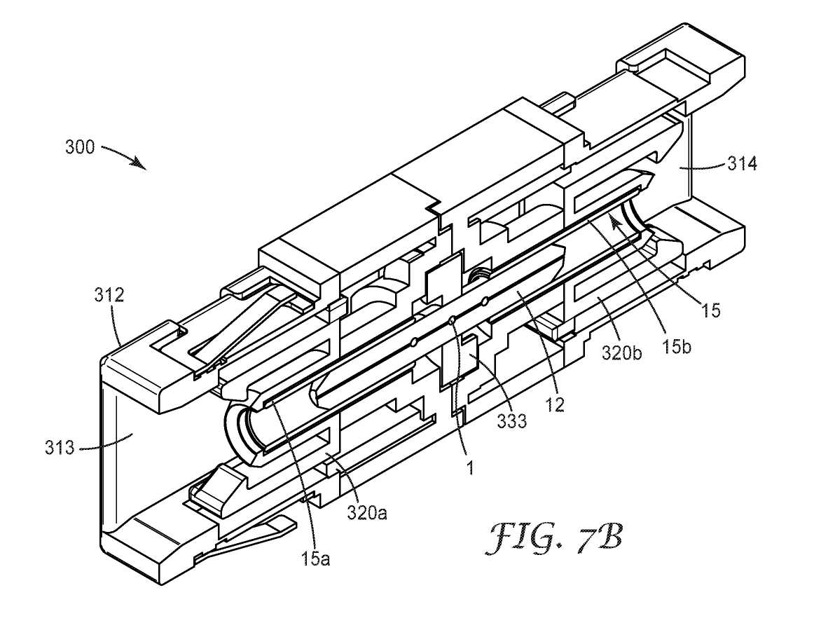

Another aspect of the invention is an optical device, such as and adapter or jumper 200 shown in FIG. 7A. In this aspect, the jumper 200 comprises a plug-receptacle, with female receptacle-male plug construction, with a housing 212 having a receptacle end 213 having a port configured to receive an SC-type optical fiber connector. Opposite end 213, housing 212 also comprises a plug end 214 that is configured to mate with a standard SC adapter or receptacle. Of course, in alternative aspects, receptacle end 213 can be configured to receive connectors of other formats as described herein and plug end 214 can be configured to mate with connectors, receptacles, or adapters of other formats as described herein. Housing 212 can be formed or molded from a polymer material, although metal and other suitably rigid materials can also be utilized.

Jumper 200 includes an article such as shown in FIG. 4 above, having an optical fiber 1 secured in a ferrule 12. In this example, fiber 1 has a first end 2 and a second end 3. The optical fiber 1 can comprise a conventional optical fiber, such as described above. A FBG 7 is written inside optical fiber 1 and can be formed as described above. First end 2 of the optical fiber 1 is coated with a multi-layer TF filter coating 5, such as described above. In this aspect, optical fiber 1, including the FBG 7 and the TF filter coating 5, is disposed within ferrule 12. Second fiber end 3 is disposed at one of the end faces 12a of ferrule 12 for mating with another fiber from an optical fiber connector. In addition, in some aspects, one or both of fiber end surfaces 2 and 3 can be angle cleaved or flat.

In one aspect, ferrule 12 comprises a ceramic ferrule, where the ceramic material has a limited thermal expansion, so any induced wavelength drift can be minimized due to the confinement of the FBG 7 within the ceramic ferrule 12. In this aspect, this mating end 12a of the ferrule 12 can be disposed in a sleeve 15, which can be formed from a ceramic material, and can be disposed in a collar body 220. The collar body 220 can be a multi-purpose element that can house the ferrule 12 and fiber 1, as well as the sleeve 15. In addition, a short fiber piece 9′ can be bonded or otherwise attached to the end surface 2 of optical fiber 1. In this aspect, ferrule 12 includes one or more through holes 13 which allow an adhesive to be applied at various locations, such as, for example, at the interface of end face 2 and fiber piece 9′. In this manner, the TF coating 5 can be protected from damage during coupling operations. In this aspect of the invention, fiber 1 can have a length of from about 5 mm to about 200 mm, from about 5 mm to about 50 mm, or from about 5 mm to about 20 mm, and short fiber piece 9′ can have a length of from about 1 mm to about 100 mm. As such, optical jumper 200 can be of very compact length and can be easily installed at a network node or other location.

Another aspect of the invention is an optical device, such as adapter 300 shown in FIG. 7B. In this aspect, the adapter 300 is constructed as a female-female adapter, with a housing 312 having a first receptacle end 313 having a port configured to receive an SC-type optical fiber connector. Opposite end 313, housing 312 also comprises a second receptacle end 314 that is configured to receive an SC-type optical fiber connector. Of course, in alternative aspects, receptacle ends 313, 314 can be configured to receive connectors of other formats as described herein. Housing 312 can be formed or molded from a polymer material, although metal and other suitably rigid materials can also be utilized.

Adapter 300 includes an article such as shown in FIGS. 4 and 7A having an optical fiber 1 secured in a ferrule 12. The optical fiber 1 can comprise a conventional optical fiber, such as described above. A FBG is written inside optical fiber 1 and can be formed as described above. A first end of the optical fiber 1 can be coated with a multi-layer TF filter coating such as described above. In this aspect, optical fiber 1, including the FBG and the TF filter coating, is disposed within ferrule 12. A second fiber end can be disposed at one of the end faces of ferrule 12 for mating with another fiber from an optical fiber connector. In addition, in some aspects, one or both of fiber end surfaces can be angle cleaved or flat.

In one aspect, ferrule 12 comprises a ceramic ferrule, where the ceramic material has a limited thermal expansion, so any induced wavelength drift can be minimized due to the confinement of the FBG within the ceramic ferrule 12. In the aspect of FIG. 7B, the ferrule 12 can be disposed in a sleeve 15, which can be formed from a ceramic material. In one aspect, sleeve 15 comprises a split sleeve having two sleeve components 15a and 15b, where sleeve component 15a is disposed in retainer 320a and sleeve component 15b is disposed in retainer 320b. A ferrule holder 333 can be used to hold ferrule 12 within housing 312. The retainers 320a, 320b can secure and house different portions of split sleeve 15. In addition, a short fiber piece can be bonded or otherwise attached to an end surface of optical fiber 1. Also, ferrule 12 can include one or more through holes, such as described above. In this aspect of the invention, the overall length of ferrule 12 can be from about 5 mm to about 200 mm, from about 5 mm to about 100 mm, or from about 5 mm to about 20 mm. As such, adapter 300 can be of very compact length and can be easily installed at a network node or other location.

In addition to the exemplary optical devices described in FIGS. 6. 7A and 7B, the optical fiber articles described herein can be employed in other optical devices, for example an optical transceiver, or other small form factor configurations, as would be apparent to one of ordinary skill in the art given the present description.

As mentioned above, FIG. 8 provides a plot showing the isolation provided by an optical fiber that is constructed in a manner similar to optical fiber 1. In that experiment, the isolation of the data band signal from the monitoring band is increased from 35 dB to over 50 dB using a TF filter in combination with a FBG.

In the experiment, a fiber assembly was utilized. A ferrule-mounted first fiber comprised a 15 mm optical fiber stub (Ge-doped SMF) having an embedded FBG, with a FBG length of about 9 mm and a reflection >99% at 1650 nm. The first fiber was spliced to a second fiber (a 300 mm pigtail) having a TF filter coating on one end having reflection >95% at 1650 nm. The TF filter coated surface was physically spliced to the first fiber such that the distance between the FBG and the TF filter was about 5 mm. A broadband signal was transmitted through a 2×1 coupler such that the broadband signal enters the ferrule end of the first fiber. The broadband signal was transmitted through the fiber assembly into a first optical spectrum analyzer (OSA) which measures the transmitted signal. The reflected portion of the broadband signal is reflected back into the 2×1 coupler and is measured with a second optical spectrum analyzer. FIG. 8 shows the transmission of the broadband signal as measured by the first OSA (for the FBG alone, the TF filter alone, and the combination of FBG and TF filter in the fiber assembly).

This degree of isolation compares favorably with conventional configurations of multiple FBGs concatenated in series. An FBG can have high transmission loss especially at hydrogen absorption wavelength band even for single grating operation, thus concatenating two or more FBG together will create even higher transmission loss. Also, multiple FBGs concatenated together can also pose a challenge to the thermal stability control and packaging. If multiple FBGs are connected in serial, then a much longer customized ferrule will need to be made and the footprint of the final packaged device will be much larger.

In aspects of the present invention, depositing a TF filter provides high isolation and is intrinsically thermally stable because of its extremely small thickness compared to a FBG. The transmission loss of a TF filter is also nearly 0 (<0.05 dB). A TF filter does not require extra temperature control to achieve thermal stability.

The optical devices described above can be used in PON monitoring and point to point communication. For example, a central office can transmit an optical signal that includes a system signal and a monitoring signal. The signal is split at the cabinet location and distributed to end users, such as single family homes and buildings (e.g., multi-dwelling units). The optical connectors that include the wavelength selective stub fiber can be used to not only for termination (connectorization) of optical fibers for interconnection and cross connection in optical fiber networks inside a fiber distribution unit at an equipment room or a wall mount patch panel, inside pedestals, cross connect cabinets or closures or inside outlets in premises for optical fiber structured cabling applications, but to also provide reflection of the monitoring signal at that particular location. This system can enable the network operator to determine fault location or line degradation for a specific subscriber ID, for example, based on a signal comparison against an initial installation performance state.

Various modifications, equivalent processes, as well as numerous structures to which the present invention may be applicable will be readily apparent to those of skill in the art to which the present invention is directed upon review of the present specification.

1. An article comprising:
an optical fiber having a first end with a first end surface having a multilayer thin film filter coating deposited thereon, a second end with a second end surface, and a fiber Bragg grating formed within the optical fiber between the first and second ends.

2. The article of claim 1, wherein the first end surface has an angle from about 1 degree to about 10 degrees with respect to a plane that is perpendicular to an optical axis of the fiber.

3. The article of claim 1, wherein the second end surface has a multilayer thin film filter coating deposited thereon.

4. The article of claim 1, wherein the fiber has a length of from about 5 mm to about 50 mm.

5. The article of claim 1, wherein the thin film filter coating transmits light having a wavelength of about 1260 nm to about 1600 nm and reflects light having a wavelength of about 1620 nm to about 1690 nm.

6. The article of claim 1, wherein the fiber Bragg grating has a transmission of <25% and a reflectivity of >75% at 1650 nm (+/−10 nm).

7. An article comprising:
a first optical fiber having a first end with a first end surface having a multilayer thin film filter coating deposited thereon, a second end with a second end surface, and a first fiber Bragg grating formed within the first optical fiber between the first and second ends; and
a second optical fiber having a second fiber Bragg grating formed therein, wherein an end surface of the second optical fiber is attached to the first optical fiber at the first end surface.

8. An article comprising:
a ferrule; and
an optical fiber having a first end with a first end surface having a multilayer thin film filter coating deposited thereon, a second end with a second end surface, and a fiber Bragg grating formed within the optical fiber between the first and second ends, wherein at least the portion of the optical fiber having the fiber Bragg grating formed therein is disposed within the ferrule.

9. The article of claim 8, wherein an entire length of the optical fiber is disposed within the ferrule.

10. An optical device comprising the article of claim 1.

11. The optical device of claim 10, wherein the optical device comprises an optical fiber connector.

12. The optical device of claim 10, wherein the optical device comprises an optical fiber receptacle.

13. The optical device of claim 10, wherein the optical device comprises an optical jumper.

14. The optical device of claim 10, wherein the optical device comprises an optical adapter.

15. The optical device of claim 11, further comprising a mechanical splice device, wherein the second end of the optical fiber mates with a field fiber in a splice element of the mechanical splice device.

16. The optical device of claim 10, wherein the optical fiber comprises a stub fiber.

17. The optical device of claim 10, wherein an isolation of a data band signal from a monitoring band is at least 50 dB.

18. A passive optical network (PON) comprising the optical device of claim 10.
